(19) United States
(12) Patent Application Publication
(10) Pub. No.: US 2026/0336936 A1
(43) Pub. Date: Oct. 29, 2026

(54) AUTOMATIC TRANSPORT DEVICE

(71) Applicant: SHARP KABUSHIKI KAISHA, Osaka (JP)

(72) Inventor: MASAKI NAKAURA, Osaka (JP)

(21) Appl. No.: 19/576,573

(22) Filed: Mar. 24, 2026

(30) Foreign Application Priority Data
Apr. 23, 2025 (JP) 2025-071039

(51) Int. Cl. B65G 1/137; B25J 11/00; B66F 9/065

(52) U.S. Cl. CPC B65G 1/1378; B25J 11/00; B66F 9/065; B65G 2203/0216; B65G 2203/041

(57) ABSTRACT

An automatic transport device can transport a storage shelf in a state of being coupled with the storage shelf. The automatic transport device includes a coupler that is allowed to switch between a coupled state of being coupled with the storage shelf and a non-coupled state of not being coupled with the storage shelf, a transferrer that takes a transport target object into and out of the storage shelf in the coupled state, and a traveler that causes the automatic transport device to travel in the coupled state.

### INCORPORATION BY REFERENCE

This application is based upon and claims the benefit of priority from the corresponding Japanese Patent Application No. 2025-071039 filed on April 23, 2025, the entire contents of which are incorporated herein by reference.

### BACKGROUND

The disclosure relates to an automatic transport device that transports a transport target object.

In the related art, in a warehouse or the like, an automatic transport device that takes out an article as a transport target (transport target object) from a storage shelf to transport the article to a target location (such as a retrieval location) is known. For example, a technique is known in which, in a transport robot (automatic transport device) integrated with a storage shelf, a transport device including a telescopic boom and a manipulator attached to the storage shelf takes an article into and out of the storage shelf.

In the automatic transport device in the related art, since the storage shelf is integrated, for example, when the transport target object stored in the storage shelf is carried out to the target location, the automatic transport device needs to perform an operation of carrying out the transport target object from the storage shelf after arriving at the target location. When there are many transport target objects stored in the storage shelf, an operation time becomes long, and during that time, the automatic transport device needs to stay at the location for a long time, and there is a problem that operational efficiency of the transport operation is lowered.

An object of the disclosure is to provide an automatic transport device capable of improving operational efficiency of a transport operation of transporting a transport target object by the automatic transport device.

### SUMMARY

An automatic transport device according to an aspect of the disclosure is an automatic transport device allowed to transport a storage shelf in a state of being coupled with the storage shelf. The automatic transport device includes a coupler that is allowed to switch between a coupled state of being coupled with the storage shelf and a non-coupled state of not being coupled with the storage shelf, a transferrer that takes a transport target object into and out of the storage shelf in the coupled state, and a traveler that causes the automatic transport device to travel in the coupled state.

According to the disclosure, it is possible to provide an automatic transport device capable of improving operational efficiency of a transport operation of transporting a transport target object by the automatic transport device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view illustrating an overall configuration of an automatic transport system according to an embodiment of the disclosure.

FIG. 2 is a perspective view illustrating the overall configuration of the automatic transport device according to the embodiment of the disclosure.

FIG. 3 is a perspective view illustrating an overall configuration of a storage shelf according to the embodiment of the disclosure.

FIG. 4 is a side view illustrating the overall configuration of the automatic transport device according to the embodiment of the disclosure.

FIG. 5 is a front view illustrating the overall configuration of the automatic transport device according to the embodiment of the disclosure.

FIG. 6 is a diagram illustrating an example of a method of coupling the automatic transport device with the storage shelf according to the embodiment of the disclosure.

FIG. 7 is a diagram illustrating the example of the method of coupling the automatic transport device with the storage shelf according to the embodiment of the disclosure.

FIG. 8 is a diagram illustrating the example of the method of coupling the automatic transport device with the storage shelf according to the embodiment of the disclosure.

FIG. 9A is a plan view illustrating a configuration of a transferrer according to the embodiment of the disclosure.

FIG. 9B is a plan view illustrating the configuration of the transferrer according to the embodiment of the disclosure.

FIG. 10 is a diagram illustrating an example of a picking method performed in the automatic transport device according to the embodiment of the disclosure.

FIG. 11 is a diagram illustrating the example of the picking method performed in the automatic transport device according to the embodiment of the disclosure.

### DETAILED DESCRIPTION

Hereinafter, embodiments of the disclosure will be described with reference to the accompanying drawings for an understanding of the disclosure. Note that the following embodiments are specific examples of the disclosure, and do not limit the technical scope of the disclosure.

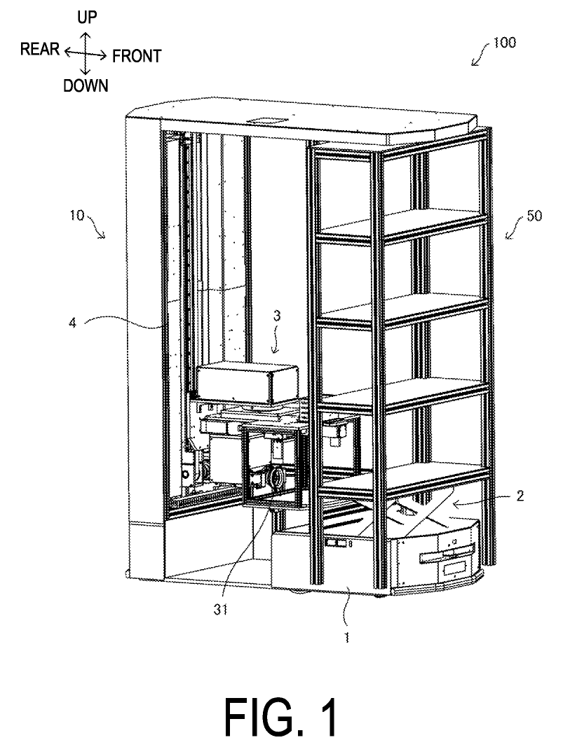

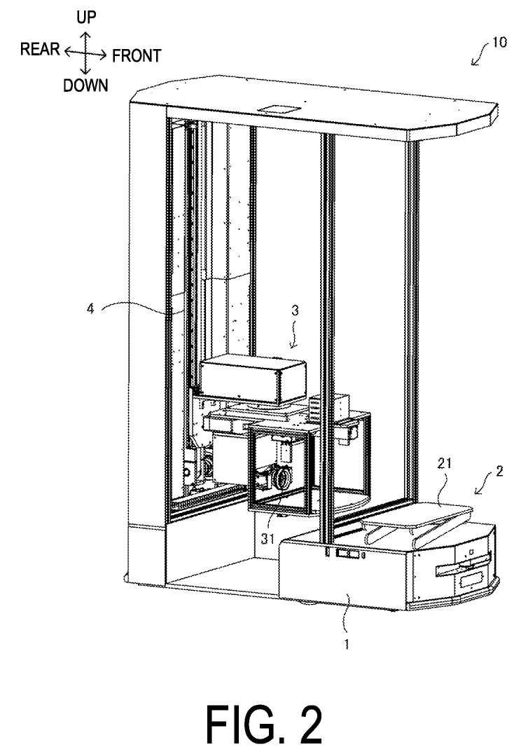

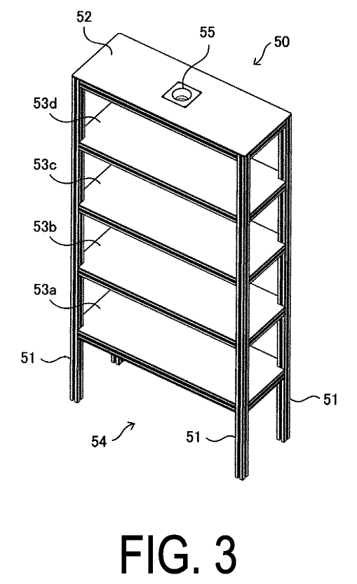

FIG. 1 is a perspective view illustrating an overall configuration of an automatic transport system 100 according to an embodiment of the disclosure. The automatic transport system 100 includes a storage shelf 50 and an automatic transport device 10 capable of transporting the storage shelf 50 in a coupled state. FIG. 2 is a perspective view illustrating an overall configuration of the automatic transport device 10, and FIG. 3 is a perspective view illustrating an overall configuration of the storage shelf 50. FIG. 1 illustrates a state in which the storage shelf 50 and the automatic transport device 10 are connected with each other (the coupled state), and FIG. 2 illustrates the automatic transport device 10 in a state in which the storage shelf 50 and the automatic transport device 10 are not connected with each other (a non-coupled state).

The automatic transport device 10 is a transport vehicle capable of unmanned traveling (automatic guided vehicle). The automatic transport device 10 is configured to be capable of forward traveling, backward traveling, and turning traveling. For example, when moving to a location of the storage shelf 50 as a coupling target and coupled with the storage shelf 50 in a warehouse, the automatic transport device 10 moves to a destination (retrieval location) in a state of being coupled with the storage shelf 50, and releases the coupling with the storage shelf 50 at the retrieval location. Further, the automatic transport device 10 performs a picking operation (storage and retrieval operation) such as storing (storage) an article as a transport target (transport target object) in the storage shelf 50 in the coupled state or taking out (retrieval) an article stored in the storage shelf 50.

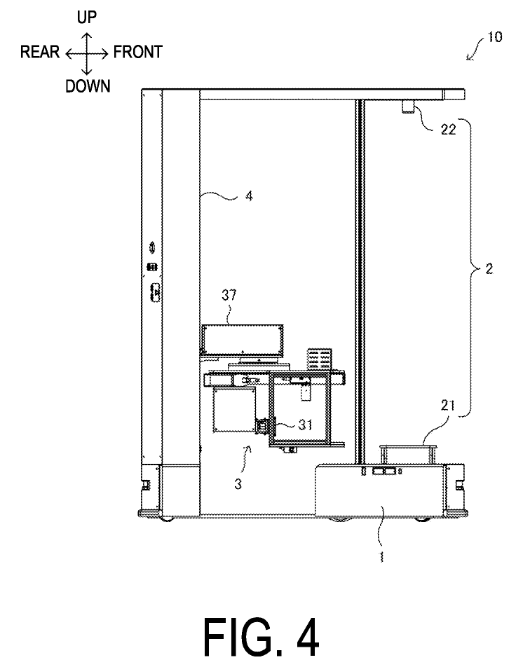

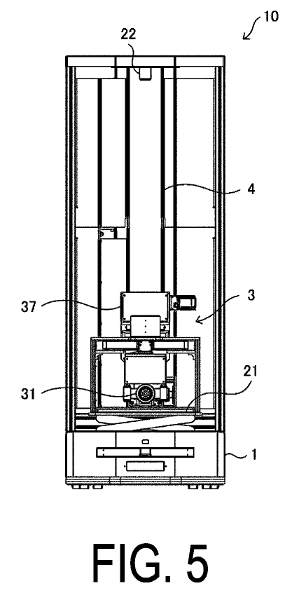

The storage shelf 50 is a general storage shelf for storing articles, and includes one or more stages (four stages in FIG. 3) of bays (shelf plates). To be specific, the storage shelf 50 includes four leg portions 51 (support columns) that are grounded on a floor surface, a top plate 52, and four shelf plates 53 (shelf plates 53a, 53b, 53c, and 53d). A space 54 having a predetermined height is formed between a bottom surface (the shelf plate 53a at a lowermost stage) of the storage shelf 50 and the floor surface. In addition, a receiving portion 55 (fitted portion) that receives a fitting portion 22 (see FIG. 4, FIG. 5, and the like) provided at the automatic transport device 10 is formed at the top plate 52. In the warehouse, a plurality of types of the storage shelves 50 having different sizes, different numbers of stages, and the like may be disposed. Note that in a state of not being coupled with the automatic transport device 10, articles need not be stored in the storage shelf 50.

Further, in addition to the storage shelf 50, a plurality of article shelves 60 in which articles are stored are disposed in the warehouse. A server (not illustrated) that manages the articles in the warehouse manages article information such as a name, a code, a type, and a size of each article, and identification information (a shelf code) of the article shelf 60 in which each article is stored. Thus, the server can specify an article stored in each article shelf 60 and specify a storage location (article shelf 60) of each article. The server outputs a transport request (retrieval request) related to an article as a retrieval target to the automatic transport device 10 based on a retrieval request acquired from outside. The retrieval request includes information such as a storage location of an article (a position, identification information, and the like of the article shelf 60), an article name, and a picking quantity. Upon acquiring the transport request from the server, the automatic transport device 10 moves to the storage location (the article shelf 60) where the article as the retrieval target is stored, receives the article, temporarily stores the article in the storage shelf 50 coupled with the automatic transport device 10, and moves to a retrieval location.

Note that the storage shelf 50 may be included in the article shelf 60. That is, the automatic transport device 10 may be coupled with the article shelf 60 and transport the article shelf 60. Therefore, the article shelf 60 may have an identical configuration to that of the storage shelf 50 (see FIG. 3).

### Configuration of Automatic Transport Device 10

FIG. 4 is a side view of the automatic transport device 10, and FIG. 5 is a front view of the automatic transport device 10.

The automatic transport device 10 includes a traveler 1, a coupler 2, a transferrer 3, and a lifting device 4.

The traveler 1 causes the automatic transport device 10 to travel. A traveling method of the automatic transport device 10 is not particularly limited, and it is possible to apply a traveling method such as guide traveling that is traveling while detecting a magnetic tape installed at the floor surface, guideless traveling that is traveling on a travel route while estimating a self-position, or a two-dimensional code method that is traveling while performing fixed point correction using a two-dimensional code installed at the floor surface. Upon acquiring a transport request from the server, the traveler 1 moves the automatic transport device 10 to a location of the article shelf 60 or a retrieval location.

The coupler 2 is a coupling tool that couples the storage shelf 50 with the automatic transport device 10. Further, the coupler 2 switches between the coupled state in which the automatic transport device 10 is coupled with the storage shelf 50 and the non-coupled state in which the automatic transport device 10 is not coupled with the storage shelf 50. Specifically, the coupler 2 includes a lift portion 21 that raises and lowers the storage shelf 50, and the fitting portion 22 that is fitted to the receiving portion 55 (see FIG. 3) of the top plate 52 of the storage shelf 50. The fitting portion 22 is fitted to the receiving portion 55 of the top plate 52 as the storage shelf 50 is raised by the lift portion 21.

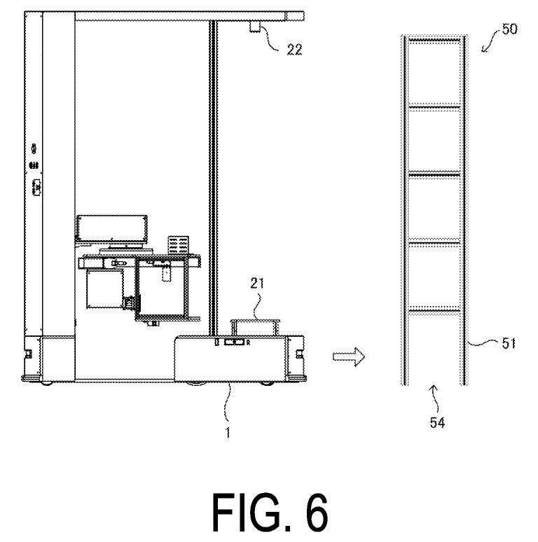

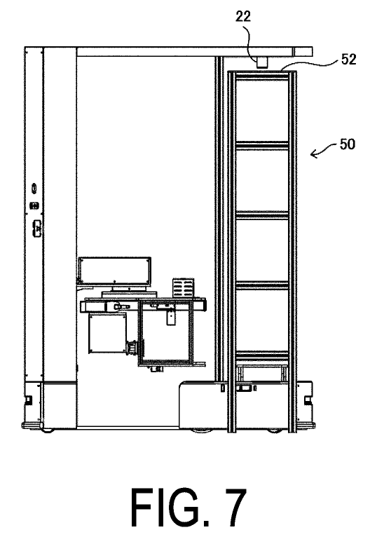

A specific example of the method of coupling the storage shelf 50 will be described with reference to FIGS. 6-8. Upon acquiring the transport request from the server, the traveler 1 moves the automatic transport device 10 to a location where the storage shelf 50 is disposed (see FIG. 6). Next, the traveler 1 causes the automatic transport device 10 to move forward so that a housing of the traveler 1 moves into (enters) the space 54 of the storage shelf 50 (see FIG. 6). At this time, the coupler 2 sets the lift portion 21 at a lowermost position. FIG. 7 illustrates a state in which the traveler 1 moving into the space 54. Note that the state illustrated in FIG. 7 illustrates a state in which the automatic transport device 10 and the storage shelf 50 are not coupled with each other.

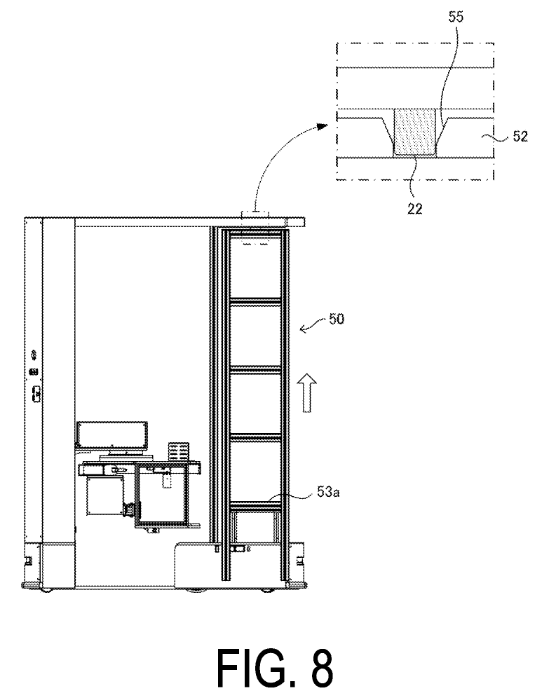

Upon detecting the traveler 1 moving into (entering) the space 54, the coupler 2 raises the lift portion 21. The coupler 2 may detect the traveler 1 moving into the space 54 by a camera or a sensor. The lift portion 21 comes into contact with the bottom surface (the shelf plate 53a at the lowermost stage) of the storage shelf 50 by being raised, and is subsequently raised to lift the storage shelf 50 (see FIG. 8). As a result, the storage shelf 50 is separated from the floor surface. The coupler 2 further raises the lift portion 21 to couple the storage shelf 50. Specifically, as illustrated in FIG. 8, the storage shelf 50 is raised by raising the lift portion 21, and the fitting portion 22 enters the receiving portion 55 of the top plate 52 as the storage shelf 50 is raised. When the fitting portion 22 is fitted to the receiving portion 55, the coupler 2 stops the lift portion 21 from being raised. Accordingly, the storage shelf 50 is coupled with the automatic transport device 10, and the storage shelf 50 and the automatic transport device 10 enter the coupled state.

When releasing the coupled state, the coupler 2 lowers the lift portion 21, the storage shelf 50 is lowered, and the fitting portion 22 is detached from the receiving portion 55 as the storage shelf 50 is lowered. By the coupler 2 further lowering the lift portion 21, the leg portions 51 of the storage shelf 50 come into contact with the floor surface, and by the coupler 2 lowering the lift portion 21 to the lowermost position, the coupled state between the storage shelf 50 and the automatic transport device 10 is released and the storage shelf 50 and the automatic transport device 10 enter the non-coupled state.

In this manner, the coupler 2 switches between the coupled state (see FIG. 8) in which the automatic transport device 10 and the storage shelf 50 are coupled with each other and the non-coupled state (see FIG. 6) in which the automatic transport device 10 and the storage shelf 50 are not coupled with each other by raising and lowering the lift portion 21.

The traveler 1 can cause the automatic transport device 10 to travel with the storage shelf 50 coupled (with the storage shelf 50 lifted). Note that since the storage shelf 50 is fixed in an up-down direction by the lift portion 21 and the fitting portion 22, stability during traveling can be ensured.

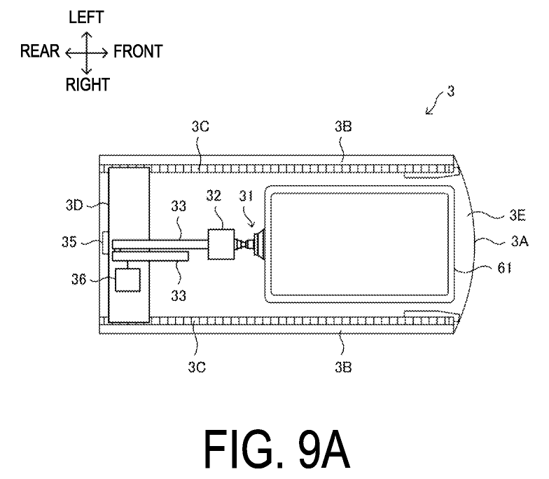

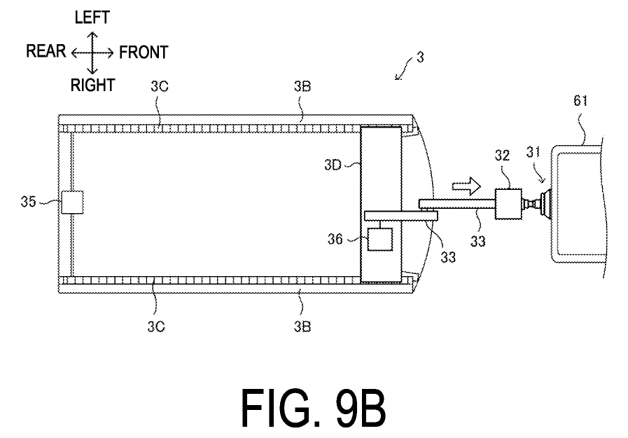

The transferrer 3 performs picking (storage and retrieval) of an article as a transport target. Specifically, the transferrer 3 takes an article into and out of the storage shelf 50 in the state in which the automatic transport device 10 and the storage shelf 50 are coupled with each other. FIGS. 9A and 9B are plan views illustrating a configuration of the transferrer 3. The transferrer 3 includes a telescopic arm 33 that extends and retracts in a horizontal direction (front-rear direction in FIG. 9), a holder 31 that is provided at the telescopic arm 33 and holds an article, and a lifting driver 37 (see FIG. 4) that raises and lowers the telescopic arm 33 and the holder 31 in the up-down direction. The transferrer 3 controls a position of the telescopic arm 33 and the holder 31 in the up-down direction with respect to the storage shelf 50 and an extension length of the telescopic arm 33. FIG. 9A illustrates a state in which the telescopic arm 33 is retracted, and FIG. 9B illustrates a state in which the telescopic arm 33 is extended.

To be specific, the transferrer 3 includes a bottom plate 3A, a sidewall 3B rising upward from the bottom plate 3A, a rail 3C provided at the sidewall 3B, a base portion 3D connected to the rail 3C, the telescopic arm 33 connected to the base portion 3D, the holder 31 (a binder) connected to the telescopic arm 33, drive motors 35 and 36, and a rotary shaft (not illustrated) that supports the transferrer 3 so as to be rotatable in the horizontal direction.

The bottom plate 3A includes a slide surface 3E. The bottom plate 3A holds an article 61 on the slide surface 3E so as to be slidable and movable in the front-rear direction. The slide surface 3E may be implemented using a plurality of roller members, or may be implemented using a board member made of a material (such as resin) that allows the article 61 to slide and move.

The sidewalls 3B are provided at both ends of the transferrer 3, respectively, and a space is formed between the sidewalls 3B into and from which the article 61 can be taken in and out. The rail 3C extending in the front-rear direction is provided inside the sidewalls 3B.

The base portion 3D is connected to the rail 3C so as to be movable in the front-rear direction above the slide surface 3E. The base portion 3D is configured to be movable on the rail 3C in the front-rear direction. The drive motor 35 slides and moves the base portion 3D in the front-rear direction on the rail 3C.

The base portion 3D is provided with the drive motor 36 and the telescopic arm 33. To be specific, the drive motor 36 is disposed at an upper surface of the base portion 3D. The telescopic arm 33 has one end fixed to the upper surface of the base portion 3D, and is connected to the drive motor 36. The telescopic arm 33 has a configuration that is extendable and retractable in the front-rear direction. For example, the telescopic arm 33 includes a multistage telescopic mechanism that is extendable and retractable in the front-rear direction.

The drive motor 36 moves (extends and contracts) the telescopic arm 33 in the front-rear direction by, for example, rotating a rotating belt connected to the telescopic arm 33. As described above, in the transferrer 3, the drive motor 35 moves the base portion 3D in the front-rear direction on the slide surface 3E, and the drive motor 36 extends and retracts the telescopic arm 33 in the front-rear direction on the base portion 3D.

The holder 31 is disposed at a tip end of the telescopic arm 33 and is bound to a side surface of the article 61. Specifically, the holder 31 includes an attraction portion that adheres to the side surface of the article 61, and an attraction unit that is disposed on the tip end side of the telescopic arm 33 in the front-rear direction and applies an attractive force to the attraction portion. The attraction portion attracts the side surface of the article 61 by the attractive force (suction force) applied from the attraction unit. Note that the attraction unit includes a vacuum pump that draws in air in the attraction portion, and has a structure in which air in an internal space of a suction cup of the attraction portion is drawn in and discharged by the vacuum pump. For example, when the vacuum pump is driven, the air in the suction cup is drawn in, and the suction cup adheres to an object (the article 61).

A signal cable (not illustrated) is connected to the holder 31. The signal cable is formed of a flexible cable and is deformable in accordance with movement of the holder 31. The signal cable is connected to the attraction unit and transmits a control signal to the attraction unit. The attraction unit drives a drive motor 32 based on the control signal to control suction and discharge of air by the vacuum pump.

The transferrer 3 is connected to the lifting device 4 (see FIGS. 4 and 5) including a rail extending in the up-down direction, and the lifting driver 37 drives a drive motor to raise and lower the transferrer 3. Further, the transferrer 3 rotates and moves in the horizontal direction (clockwise or counterclockwise).

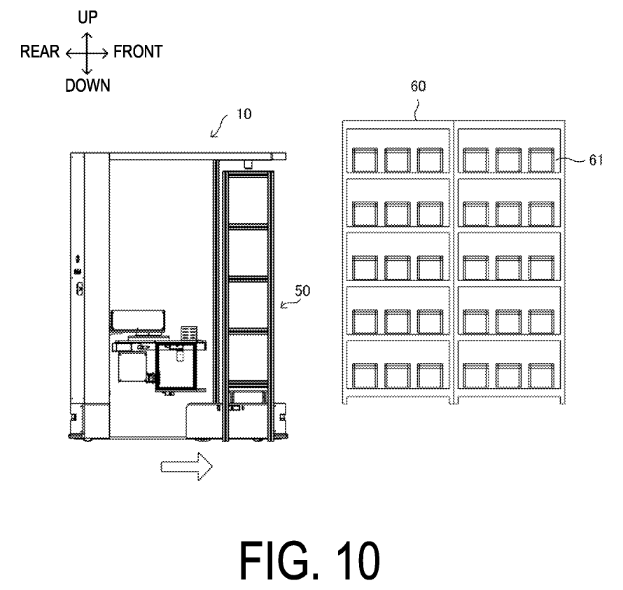

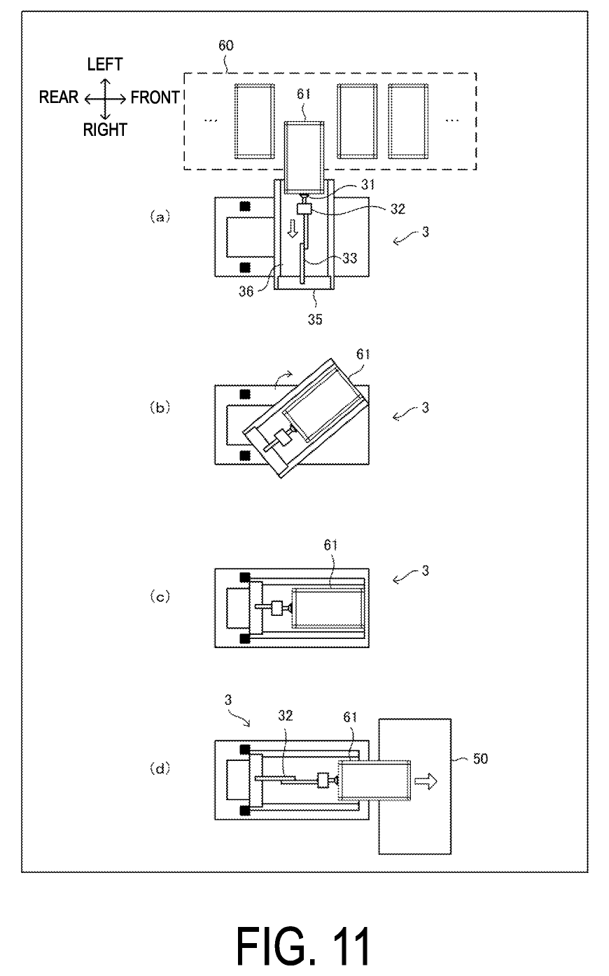

FIGS. 10 and 11 illustrate a specific example of the picking operation of the article 61 by the transferrer 3. For example, after arriving in front of the article shelf 60 in which the article 61 as a picking target is stored, the automatic transport device 10 picks the target article 61 from the article shelf 60 for storage in the storage shelf 50. Specifically, when the automatic transport device 10 stops alongside in front of the article shelf 60 (see FIG. 10), the transferrer 3 rotates the transferrer 3 by 90 degrees, and then extends the telescopic arm 33 to cause the attraction portion of the holder 31 to adhere to a side surface of the article 61 as the picking target. After the attraction portion adheres to the article 61, the transferrer 3 drives the drive motor 36 to retract the telescopic arm 33 (see (a) of FIG. 11).

When the article 61 is pulled out from the article shelf 60 and placed on the transferrer 3, the transferrer 3 rotates clockwise by 90 degrees (see (b) and (c) of FIG. 11). Next, the transferrer 3 is moved (raised or lowered) to a target storage position (empty space) of the storage shelf 50 in accordance with an instruction from the lifting device 4. After arriving at the target position (height), the transferrer 3 extends the telescopic arm 33 in a direction of the storage shelf 50 (forward direction in FIG. 11), thereby sliding and moving the article 61 on the slide surface 3E and pushing the article 61 into the storage shelf 50 (see (d) of FIG. 11). In this way, the transferrer 3 picks the article 61 as a transport target from the article shelf 60 for movement to the storage shelf 50 coupled with the automatic transport device 10.

When picking the article 61 stored in the storage shelf 50 for movement to the article shelf 60, the transferrer 3 performs a reverse operation of the above-described procedure ((a) to (d) of FIG. 11).

In this way, the transferrer 3 takes in and out the article 61 between the article shelf 60 positioned in a left-right direction of the automatic transport device 10 and the storage shelf 50 coupled with the automatic transport device 10.

When the article 61 is stored in the storage shelf 50, in order to transport the article 61 to a retrieval location, the traveler 1 causes the automatic transport device 10 to travel to the retrieval location with the storage shelf 50 coupled. When the automatic transport device 10 arrives at a retrieval location, the coupler 2 lowers the lift portion 21 to release the coupling with the storage shelf 50 (see FIGS. 6 and 7). Thereafter, the automatic transport device 10 separates the storage shelf 50 at the retrieval location and couples an empty storage shelf 50 in which no article is stored. Then, the automatic transport device 10 moves to a location of the article shelf 60 in which the article 61 as a next picking target is stored. In this way, when the automatic transport device 10 arrives at the target location (retrieval location), the coupler 2 switches from the coupled state to the non-coupled state, and the traveler 1 causes the automatic transport device 10 to travel in the non-coupled state.

As described above, the automatic transport device 10 picks the target article 61 from the article shelf 60 for storage in the storage shelf 50 according to the transport request, and moves the storage shelf 50 to the retrieval location. Further, when the coupling with the storage shelf 50 is released, the automatic transport device 10 is coupled with another storage shelf 50 in accordance with a next transport request, and then performs the picking operation of the article 61 as a transport target. At the retrieval location, a retrieval person performs a retrieval operation by taking out the article 61 from the storage shelf 50 for which the coupling with the automatic transport device 10 is released.

According to the above configuration, the automatic transport device 10 can move for a next picking operation with the storage shelf 50 separated at the retrieval location. Thus, the automatic transport device 10 does not need to wait for the article 61 to be retrieved from the storage shelf 50 at the retrieval location. Thus, operational efficiency of a transport operation of the article 61 can be improved.

### Other Embodiments

As another embodiment of the automatic transport device 10 according to the disclosure, the transferrer 3 may acquire identification information with which a type of the storage shelf 50 can be identified, and may take in and out the article 61 based on the identification information. For example, when a size of the article 61 as a picking target included in a transport request is a first size, the transferrer 3 specifies the storage shelf 50 that can store the article 61 of the first size. For example, the transferrer 3 includes a camera (imager), and identifies a type of the storage shelf 50 based on a captured image of the storage shelf 50 captured by the camera. Here, the transferrer 3 specifies the storage shelf 50 having a bay of the first size based on captured images of a plurality of the storage shelves 50. The transferrer 3 may specify the type of storage shelf 50 based on identification information (for example, a shelf number, a two-dimension code, or the like) attached to each storage shelf 50, or may specify the type of storage shelf 50 by analyzing an entire shape and the number of stages of the storage shelf 50.

Further, when the number of articles 61 as picking targets included in a transport request is N, the transferrer 3 specifies the storage shelf 50 that can store N pieces of the articles 61. For example, when the number of the articles 61 as picking targets is four, the transferrer 3 specifies the storage shelf 50 having four or five or more stages based on captured images of a plurality of the storage shelves 50.

As yet another embodiment, the coupler 2 may acquire identification information with which a type of the article 61 to be stored in the storage shelf 50 can be identified, and couple the storage shelf 50 according to the identification information. The coupler 2 may include a camera that captures an image of the article 61, and may identify a type of the article 61 based on a captured image of the article 61. For example, when the article 61 imaged by the camera is a component, the coupler 2 specifies and couples the storage shelf 50 capable of storing the component. Further, for example, when the article 61 imaged by the camera is a food, the coupler 2 specifies and couples the storage shelf 50 capable of storing the food.

In this manner, the automatic transport device 10 may specify and couple the storage shelf 50 as a coupling target based on article information such as a size and a type of the article 61 as a transport target.

### Supplements of Disclosure

Hereinafter, an outline of the disclosure extracted from the above-described embodiments will be described as supplements. Configurations and processing functions described in the following supplements can be selected and combined as desired.

### Supplement 1

An automatic transport device allowed to transport a storage shelf in a state of being coupled with the storage shelf, the automatic transport device including
a coupler that is allowed to switch between a coupled state of being coupled with the storage shelf and a non-coupled state of not being coupled with the storage shelf,
a transferrer that takes a transport target object into and out of the storage shelf in the coupled state, and a traveler that causes the automatic transport device to travel in the coupled state.

### Supplement 2

The automatic transport device according to Supplement 1, in which
the storage shelf includes a leg portion that is grounded on a floor surface, and includes a space between a bottom surface of the storage shelf and the floor surface into which the automatic transport device is allowed to enter,
the coupler includes a lift portion that lifts the storage shelf,
the traveler causes the automatic transport device to travel to cause the lift portion to enter the space, and
the coupler raises the lift portion in the space to lift and couple the storage shelf.

### Supplement 3

The automatic transport device according to Supplement 2, in which
the coupler includes a fitting portion that is fitted to a top plate of the storage shelf, and
the fitting portion is fitted to the top plate as the storage shelf is raised by the lift portion.

### Supplement 4

The automatic transport device according to Supplement 2 or 3, in which
the traveler causes the automatic transport device to travel in a state in which the coupler lifts the storage shelf.

### Supplement 5

The automatic transport device according to any one of Supplements 2 to 4, in which
the transferrer acquires identification information with which a type of the storage shelf is identifiable, and takes in and out the transport target object based on the identification information.

### Supplement 6

The automatic transport device according to Supplement 5, in which
the transferrer includes
   an arm that extends and retracts in a horizontal direction,
   a holder that is provided at the arm and holds the transport target object, and
   a lifting driver that raises and lowers the arm and the holder in an up-down direction, and
the transferrer controls a position of the arm and the holder in the up-down direction with respect to the storage shelf and an extension length of the arm based on the identification information.

### Supplement 7

The automatic transport device according to Supplement 5 or 6, in which
the transferrer includes an imager that captures an image of the storage shelf, and identifies a type of the storage shelf based on a captured image of the storage shelf.

### Supplement 8

The automatic transport device according to Supplement 2, in which
the coupler acquires identification information with which a type of the transport target object to be stored in the storage shelf is identifiable, and couples with the storage shelf in accordance with the identification information.

### Supplement 9

The automatic transport device according to Supplement 8, in which
the coupler includes an imager that captures an image of the transport target object, and identifies a type of the transport target object based on a captured image of the transport target object.

### Supplement 10

The automatic transport device according to any one of Supplements 1 to 9, in which
the coupler switches from the coupled state to the non-coupled state when the automatic transport device arrives at a target location, and
the traveler causes the automatic transport device to travel in the non-coupled state.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An automatic transport device allowed to transport a storage shelf in a state of being coupled with the storage shelf, the automatic transport device, comprising:
a coupler that is allowed to switch between a coupled state of being coupled with the storage shelf and a non-coupled state of not being coupled with the storage shelf;
a transferrer that takes a transport target object into and out of the storage shelf in the coupled state; and
a traveler that causes the automatic transport device to travel in the coupled state.

2. The automatic transport device according to claim 1, wherein
the storage shelf includes a leg portion that is grounded on a floor surface, and includes a space between a bottom surface of the storage shelf and the floor surface into which the automatic transport device is allowed to enter,
the coupler includes a lift portion that lifts the storage shelf,
the traveler causes the automatic transport device to travel to cause the lift portion to enter the space, and
the coupler raises the lift portion in the space to lift and couple the storage shelf.

3. The automatic transport device according to claim 2, wherein
the coupler includes a fitting portion that is fitted to a top plate of the storage shelf, and
the fitting portion is fitted to the top plate as the storage shelf is raised by the lift portion.

4. The automatic transport device according to claim 2, wherein
the traveler causes the automatic transport device to travel in a state in which the coupler lifts the storage shelf.

5. The automatic transport device according to claim 2, wherein
the transferrer acquires identification information with which a type of the storage shelf is identifiable, and takes in and out the transport target object based on the identification information.

6. The automatic transport device according to claim 5, wherein
the transferrer includes
an arm that extends and retracts in a horizontal direction,
a holder that is provided at the arm and holds the transport target object, and
a lifting driver that raises and lowers the arm and the holder in an up-down direction, and
the transferrer controls position of the arm and the holder in the up-down direction with respect to the storage shelf and an extension length of the arm based on the identification information.

7. The automatic transport device according to claim 5, wherein
the transferrer includes an imager that captures an image of the storage shelf, and identifies a type of the storage shelf based on a captured image of the storage shelf.

8. The automatic transport device according to claim 2, wherein
the coupler acquires identification information with which a type of the transport target object to be stored in the storage shelf is identifiable, and couples the storage shelf in accordance with the identification information.

9. The automatic transport device according to claim 8, wherein
the coupler includes an imager that captures an image of the transport target object, and identifies a type of the transport target object based on a captured image of the transport target object.

10. The automatic transport device according to claim 1, wherein
the coupler switches from the coupled state to the non-coupled state when the automatic transport device arrives at a target location, and
the traveler causes the automatic transport device to travel in the non-coupled state.
